(19) United States
(12) Patent Application Publication
(10) Pub. No.: US 2026/0236387 A1
(43) Pub. Date: Aug. 13, 2026

(54) METHOD AND SYSTEM FOR DISAGGREGATED-MEMORY-BASED LEARNED INDEX WRITE EXTENSION

(71) Applicant: HUAZHONG UNIVERSITY OF SCIENCE AND TECHNOLOGY, Wuhan (CN)

(72) Inventors: Haikun LIU, Wuhan (CN); Zhuohui DUAN, Wuhan (CN); Bangyu LI, Wuhan (CN); Xiaofei LIAO, Wuhan (CN); Hai JIN, Wuhan (CN)

(21) Appl. No.: 19/302,334

(22) Filed: Aug. 18, 2025

(30) Foreign Application Priority Data
Feb. 12, 2025 (CN) 202510156344 X

(51) Int. Cl. G06F 12/02

(52) U.S. Cl. CPC G06F 12/0223; G06F 2212/72

(57) ABSTRACT

A disaggregated-memory-based learned index write extension method and system are provided, wherein the system includes compute-pool servers and memory-pool servers. The compute-pool server holds a pointer to a write delta buffer of the reuse model, determines insertion location of key-value pairs based on a linear model in cached learned index model, and uses the held pointer to access a write delta buffer on the memory-pool server. The memory-pool server constructs the learned index model and the write delta buffer of reuse model to absorb newly inserted key-value pairs. A retraining thread in the memory-pool server asynchronously retrains submodels, scans and trains key-value pairs within the submodel, generates new bottom-layer submodels, updates the write delta buffer, and dynamically adjusts size of the write delta buffer based on data insertion characteristics within the coverage range of the submodel.

### BACKGROUND OF THE APPLICATION

### 1. Technical Field

The present disclosure relates to the field of storage and retrieval in computers, and more particularly to a disaggregated-memory-based learned index write extension method and system.

### 2. Description of Related Art

An index is regarded as a “model” for predicting locations of keys in a dataset and is therefore learnable. A learned index is a method that uses machine learning to optimize a data indexing. The core concept of a learned index is that if the data distribution and query patterns can be predicted, a machine learning model can be used to achieve functionality similar to known index structures. This approach enables the learned index to adapt to specific dataset distributions, thereby improving efficiency in storage space and query time. For example, training a neural network or regression model to predict data locations reduces addressing overheads. Recent research shows that a learned index is three times faster than B+ trees in query time and an order of magnitude lower in memory footprint. Therefore, a learned index supports efficient point and range queries with low memory space overhead. However, it is limited to static, read-only workloads, as newly inserted key-value pairs disrupt data distribution patterns, leading to performance collapse during write operations.

Attempts to extend write capabilities for learned indexes follow two main approaches. The first reserves gap spaces for key-value pairs storage and uses a model to guide insertion location searches, reducing data movements during write operations and search ranges during read operations. The second approach uses common sorted index structures to build an incremental index, temporarily recording key-value pairs and triggering retraining at specific times to merge the classical incremental sorted index with a static learned index.

In a disaggregated memory system, unrestricted write and read range, combined with complex gap formation coordination, make gap-based array write extensions unsuitable for concurrent scenarios. Similarly, tree structures incur extra network access and low cache efficiency, rendering them unsuitable as incremental buffers in concurrent scenarios.

In a disaggregated memory system, the low memory footprint of a learned index allows the entire index structure to be cached in the DRAM of the compute-pool server node, enhancing performance. In contrast, classical tree indexes, due to high memory usage, cannot be fully cached in the DRAM of the compute-pool server node, requiring access to the DRAM of the memory-pool server node for uncached portions. High network communication latency results in low throughput. Current learned indexes for disaggregated memory rely on the common sorted index structures, such as sorted linked lists. Despite using leaf list technology to locate linked list positions, these indexes still face poor write performance and massive cache misses due to oversized leaf lists.

In a disaggregated memory system with separated compute and storage resources, when the compute-pool server performs retraining, the classical retraining architecture requires reading key-value pairs to be trained from the DRAM of the memory-pool server to the local DRAM of compute-pool servers, in which their CPUs then access the local DRAM for these key-value pairs and executes an Optimal Piecewise Linear Regression (PLR) algorithm for retraining. The segmentation results are temporarily stored in the local DRAM and transmitted to the DRAM of the memory-pool server via RDMA technology. This process significantly consumes limited RDMA network bandwidth, reducing index operational efficiency.

CN115712616A discloses an indexing method based on a learned index, wherein the method includes: in response to data modification operations in a database, storing modified data in a pre-configured buffer outside the original database; and in response to a query request, querying the database using the pre-configured learning type index and verifying with the buffer. Modification operation includes at least one of addition, deletion, or replacement, with insertion and deletion sequences pre-configured in the buffer. This method has drawbacks in write extension: buffer management increases complexity, requiring a balance between memory usage and performance. A small buffer may lead to frequent data refreshes, reducing batch write efficiency. Data consistency is challenging when buffer data are not synchronized timely with the main database, especially during system failure. To prevent data loss, buffer persistence introduces additional I/O overhead, impacting write performance. Frequent write operations heighten buffer overflow risks, potentially causing urgent refreshes or operation discards, compromising system stability. Queries requiring verification via both the learned index and buffer involve complex logic, potentially degrading query performance, especially with frequent buffer content changes.

Hence, there is a need for an improved learned index write extension method for disaggregated memory systems, suitable for concurrent scenarios.

Note that, due to potential discrepancies in understanding among those skilled in the art, and the extensive literature and patents reviewed by the applicant during development, not all details are listed due to space constraints. This does not imply that the present disclosure lacks existing art features; rather, it encompasses all relevant existing art features. The applicant reserves the right to supplement this application with further details and features from related existing art, as appropriate, in accordance with relevant regulations.

### SUMMARY OF THE APPLICATION

To address the shortcomings and improvement needs of the existing art, the present disclosure provides a disaggregated-memory-based learned index write extension method and system, aiming to resolve issues with known incremental tree-based write extensions, including inability to fully cache data in the DRAM of the compute-pool server node, leading to additional network access and low cache efficiency, and rapid consumption of limited RDMA network bandwidth due to retraining initiated by the compute-pool server's CPU.

In a first aspect, the present disclosure provides a disaggregated-memory-based learned index write extension system, comprising compute-pool servers and memory-pool servers. The compute-pool server holds a pointer to a write delta buffer of reuse model and determines the insertion location of key-value pairs based on the linear model in the cached learned index model. The memory-pool server constructs the learned index model and the write delta buffer of reuse model to absorb newly inserted key-value pairs. A retraining thread in the memory-pool server asynchronously retrains submodels; the retraining thread scans and trains key-value pairs within the submodel, generates new bottom-layer submodels, updates the write delta buffer, and dynamically adjusts the size of the write delta buffer based on data insertion characteristics within the submodel's coverage range. The compute-pool server, based on the execution results of the memory-pool server's retraining thread, updates the cached submodels and the pointers held by the submodels pointing to the write delta buffer.

Through collaboration between the compute-pool server and the memory-pool server, the system achieves efficient key-value pair management and access. The compute-pool server uses the held pointer to the write delta buffer of reuse model to access the write delta buffers on the memory-pool servers and determines insertion locations using the linear model for newly inserted key-value pairs. This design avoids the space overhead of common index structures, as the compute-pool server only needs to cache the learned model and pointers to the write delta buffer, enabling the entire index structure to be cached in the compute-pool server's DRAM, thus enhancing index access speed and key-value pair operation throughput. Additionally, offloading the retraining process to the memory-pool server decouples insertion and retraining, eliminating the need to move key-value pair data between the compute-pool server and the memory-pool server, thereby reducing the burden on the RDMA network bandwidth.

In a preferred embodiment, the compute-pool server is further configured to: during the preload stage, load initial key-value pairs to the memory-pool server and sort them in ascending order; divide the sorted key-value pairs into several submodels; recursively train the submodels to obtain the middle layer and top layer of the index of the submodels; and initially allocate a continuous address space in the memory-pool server as the write delta buffer based on the size of the data nodes of the bottom-layer submodels of the learned index model.

In the preload stage, the compute-pool server sorts and divides initial key-value pairs to construct multiple submodels, then performs recursive training to form the multi-layer index structure. This approach organizes data orderly during the data import stage, improving the efficiency of subsequent data access and insertion. Initial allocation of data space for bottom-layer submodels optimizes the memory layout of the memory-pool server.

In a preferred embodiment, the memory-pool server is configured to: monitor messages of the bilateral RDMA primitive technology from the compute-pool server based on a predetermined management thread; pass anchors of intervals where retraining occurs as parameters; based on the learned index model, search for the anchors in the messages of the bilateral RDMA primitive technology and retrain old submodels into new submodels according to the search results; fill the model parameters of the new submodels and their corresponding anchor information, and allocate data nodes and the write delta buffer; wherein the management thread sends the new submodels to each compute-pool server using the bilateral RDMA primitive, enabling the compute-pool server to update the submodels.

The memory-pool server's management thread monitors messages of the bilateral RDMA primitive technology to manage data transmission and retraining processes. The efficiency of RDMA technology enables rapid data transmission and submodel updates, enhancing network bandwidth utilization and system responsiveness.

In a preferred embodiment, the memory-pool server is further configured to: have the retraining thread asynchronously migrate data from old submodels and the old write delta buffer to new submodels and the new write delta buffer, and notify the management thread of completion status upon completion.

The retraining thread migrates data from old submodels and the old write delta buffer to new submodels and the new write delta buffer, notifying the management thread of completion status. Asynchronous migration reduces system congestion, improves data update parallelism and efficiency, and ensures system stability and timely response.

In a preferred embodiment, the compute-pool server is further configured to: after segmenting the data nodes in the old submodels and the key-value pairs in the write delta buffer based on an Optimal Piecewise Linear Regression (PLR) algorithm, count the number of key-value pairs N₁ on the original data nodes and the number of key-value pairs N₂ in the write delta buffer in each segment; wherein the size of the write delta buffer is calculated as follows:

$${Size}_{Buffer} = min ( {N}_{2} / {N}_{1} * {Size}_{Node} , 2 * {Size}_{Node} ) , when {N}_{2} / {N}_{1} > 1 ;$$

$${Size}_{Buffer} = max ( {N}_{2} / {N}_{1} * {Size}_{Node} , 0.5 * {Size}_{Node} ) , when {N}_{2} / {N}_{1} < 1 ;$$

where Size_{Buffer} represents the size of the write delta buffer, Size_{Node} represents the size of the data node, N₁ represents the number of the key-value pairs on the original data nodes, and N₂ represents the number of the key-value pairs in the write delta buffer.

The memory-pool server's retraining thread uses segmentation results from the PLR algorithm to dynamically adjust the write delta buffer size based on data distribution in the data nodes and the write delta buffer within each segment. Preferably, the compute-pool server, based on the execution results of the memory-pool server's retraining thread, updates the cached submodels and the pointers held by the submodels pointing to the write delta buffer. This dynamic adjustment enhances buffer space utilization, optimizes memory usage, and ensures high system performance under various data loads.

In a preferred embodiment, the compute-pool server is further configured to: based on the cache of the learned index model, conduct a search to determine a first location offset Loc₁ on the data node to be accessed and a second location offset Loc₂ in the write delta buffer, and
calculate access space size for read/write operations as follows: Size=Size_{Bucket}*N;
where Size_{Bucket} represents the size of storage bucket, N represents the number of storage buckets for linearly probing, and Size represents the read space size specified by the read/write operations; wherein the access space ranges for the read/write operations are [Loc₁, Loc₁+Size] and [Loc₂, Loc₂+Size].

The compute-pool server determines the location offsets of data nodes and the write delta buffer using the cached learned index model and calculates the access space range for read/write operations. This precise calculation improves data access efficiency and accuracy, reduces unnecessary memory access, and optimizes overall performance.

In a second aspect, the present disclosure provides a disaggregated-memory-based learned index write extension method, comprising: setting a pointer to a write delta buffer of reuse model and determining the insertion location of key-value pairs based on the linear model in the cached learned index model; constructing the learned index model and the write delta buffer of reuse model to absorb newly inserted key-value pairs; wherein a retraining thread is used to asynchronously retrain submodels to offload the retraining process to the memory-pool server; the retraining thread scans and trains key-value pairs within the submodel, generates new bottom-layer submodels, updates the write delta buffer, and dynamically adjusts the size of the write delta buffer based on data insertion characteristics within the submodel's coverage range; based on the execution results of the memory-pool server's retraining thread, having the compute-pool server update the cached submodels and the pointers held by the submodels pointing to the write delta buffer.

Through collaboration between the compute-pool server and the memory-pool server, the method achieves efficient key-value pair management and access. The compute-pool server uses the write delta buffer of reuse model to absorb newly inserted key-value pairs and determines insertion locations using the linear model. This design avoids the space overhead of known index structures, enabling the entire index structure to be cached in the compute-pool server's DRAM, thereby enhancing index access speed and key-value pair operation throughput. Additionally, offloading the retraining process to the memory-pool server decouples insertion and retraining, eliminating the need to move key-value pair data between the compute-pool server and the memory-pool server, thereby reducing the burden on the RDMA network bandwidth.

In a preferred embodiment, the method further comprises: during the preload stage, loading initial key-value pairs to the memory-pool server and sorting them in ascending order; dividing the sorted key-value pairs into several submodels; recursively training the submodels to obtain the middle layer and top layer of the index of the submodels; initially allocating a continuous address space in the memory-pool server as the write delta buffer based on the size of the data nodes of the bottom-layer submodels of the learned index model.

In the preload stage, the method loads initial key-value pairs to the memory-pool server, sorts them, and divides them using the PLR algorithm to organize data into submodels, then recursively trains them to build the middle and top layers of the index. This ensures efficient data organization during initial loading, improving data access and insertion efficiency. Pre-allocating continuous address space as the write delta buffer optimizes subsequent memory usage and reduces dynamic allocation overhead.

In a preferred embodiment, the method further comprises: monitoring messages of the bilateral RDMA primitive technology from the compute-pool server based on a predetermined management thread; passing anchors of intervals where retraining occurs as parameters; based on the learned index model, searching for the anchors in the messages of the bilateral RDMA primitive technology and retraining old submodels into new submodels according to the search results; filling the model parameters of the new submodels and their corresponding anchor information, and allocating data nodes and the write delta buffer; wherein the management thread sends the new submodels to each compute-pool server using the bilateral RDMA primitive, enabling the compute-pool server to update the submodels.

The method of the present disclosure uses the management thread to monitor RDMA messages, ensuring efficient data transmission and updates. During retraining, old submodels are retrained into new nodes and transmitted to the compute-pool server via RDMA for updates. RDMA enhances data transmission speed and efficiency, ensuring rapid updates of model parameters and anchor information to each compute-pool server, improving system responsiveness and processing efficiency.

In a preferred embodiment, the method further comprises: the retraining thread asynchronously migrating data from old submodels and the old write delta buffer to new submodels and the new write delta buffer, and notifying the management thread of completion status upon completion. Asynchronous migration reduces system congestion, improves data update parallelism and efficiency, and ensures system stability and timely response.

### BRIEF DESCRIPTION OF THE DRAWINGS

FIG. 1 illustrates the hardware architecture of a disaggregated-memory-based learned index write extension system according to the present disclosure;

FIG. 2 is a schematic logic diagram of a disaggregated-memory-based learned index write extension method according to the present disclosure;

FIG. 3 illustrates the use of the write delta buffer according to the present disclosure;

FIG. 4 shows the flow for read data access during the retraining process according to the present disclosure;

FIG. 5 shows the flow for write data access during the retraining process according to the present disclosure;

FIG. 6 shows an example of segmentation of the memory space in a write delta buffer according to the present disclosure; and

FIG. 7 shows another example of segmentation of the memory space in a write delta buffer according to the present disclosure.

### DETAILED DESCRIPTION OF THE APPLICATION

The present disclosure is described in detail below with reference to the accompanying drawings.

Certain terms used in this disclosure are defined as follows.

A compute pool is a unified computing resource pool formed by aggregating multiple compute resources (e.g., CPUs, GPUs, memory) to enhance computing resource utilization. This resource pooling enables flexible allocation to applications and tasks, improving efficiency. Compute pools are commonly used in cloud computing environments, leveraging virtualization to allow users to dynamically adjust resource allocation based on workload and performance requirements.

A client refers to a physical server within a compute pool node, with different clients representing distinct compute-pool server nodes. In terms of resources, a client, rich in CPU resources, is termed the compute pool end. In terms of services, the compute pool collectively refers to server nodes serving users by providing key-value pair access capabilities.

A memory-pool is a technology that aggregates multiple physical storage resources (e.g., hard drives, SSDs) into a unified, manageable resource pool. It enables administrators to dynamically allocate and manage storage spaces, enhancing utilization and flexibility. Memory-pools support strategies like RAID configurations, data redundancy, and backup policies to ensure data reliability and availability, commonly used in virtualized environments to enable rapid resource allocation.

A server refers to a physical server within a memory-pool node, with different servers representing distinct memory-pool server nodes. In terms of resources, a server, rich in DRAM resources, is termed the memory-pool end. In terms of services, the memory-pool collectively refers to server nodes providing storage services by enabling key-value pair storage for clients.

A submodel is a set of parameters, intercept b and slope k, obtained using the PLR algorithm, forming a linear model loc=k*key+b, where loc is the model-predicted location and key is the key in a key-value pair.

A submodel includes the submodel, the maximum key (anchor key) among key-value pairs covered by the submodel, pointing data nodes (which store data of the key-value pairs within the submodel's coverage), pointers, write delta buffer nodes, and data nodes for global lock information.

A linear model is a linear equation loc=k*key+b, formed by parameters in a submodel, where loc is the model-predicted location, key is the key in a key-value pair, and k and b are parameters derived from the PLR algorithm.

A learned index is a tree-like structure comprising submodels and middle-layer and top-layer nodes obtained by recursively training submodels.

A write delta buffer is a data node reusing submodel parameters, formed by a continuous address space to store newly inserted key-value pairs. The storage location of a new key-value pair is calculated using submodel parameters, and the storage location address size reflects the key size.

A multi-version mechanism not only maintains pointers to data nodes and write delta buffers before retraining, but also holds pointers to newly generated data nodes and newly allocated write delta buffers after retraining, termed old and new version, respectively.

Posterior-aware static node allocation involves adjusting the size of newly allocated write delta buffers during retraining based on the ratio of key-value pairs in the write delta buffer to those in data nodes.

The preload stage is the initial generation phase of a learned index, where an application selects key-value pairs using a uniform sampling strategy based on historical key-value pair data. After sorting in ascending order, submodels are generated and recursively trained using the PLR algorithm until the number of the recursive submodels is sufficiently small (i.e. remains in single digits, or the PLR algorithm can no longer be applied).

An initial learned index is a tree-like model composed of submodels and recursively generated submodels during the preload stage.

A training-generated node is a data node produced by the PLR algorithm.

The PLR algorithm, or Optimal Piecewise Linear Regression algorithm, is a fitting algorithm in computational geometry. It takes keys sorted in ascending order as input and outputs segments of these keys with corresponding linear models. Given keys Key0 to Key100 sorted in ascending order, the PLR algorithm segments them into: Key0-Key35 with linear model loc=k0*Key+b0; Key36-Key58 with loc=k1*Key+b1; and Key59-Key100 with loc=k2*Key+b2.

The present disclosure provides a disaggregated-memory-based learned index write extension method and system. Additionally, it may encompass a disaggregated-memory-based learned index write extension apparatus, an electronic device executing the disclosed method, or a storage medium storing a program encoding the disclosed method.

### Embodiment 1

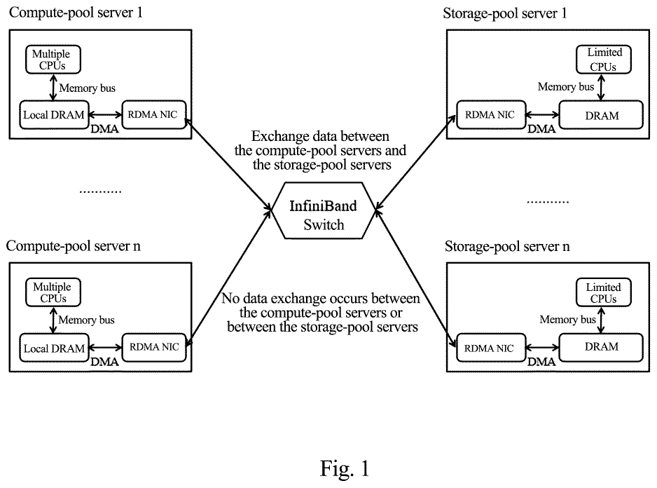

As shown in FIG. 1, a disaggregated-memory-based learned index write extension system includes multiple compute-pool servers and multiple memory-pool servers. The compute-pool servers are equipped with abundant CPU resources and limited local DRAM (used as local memory).

The memory-pool servers are equipped with limited CPU resources and abundant DRAM, used as a memory pool. The DRAM resource serves as remote large-capacity memory exposed to compute-pool servers.

In the context of the present disclosure, RDMA (Remote Direct Memory Access) networking technology enables memory extension. All compute-pool servers and memory-pool servers are equipped with an RDMA NIC (Network Interface Card). Multiple compute-pool servers and memory-pool servers are interconnected via a dedicated InfiniBand switch, forming an RDMA network.

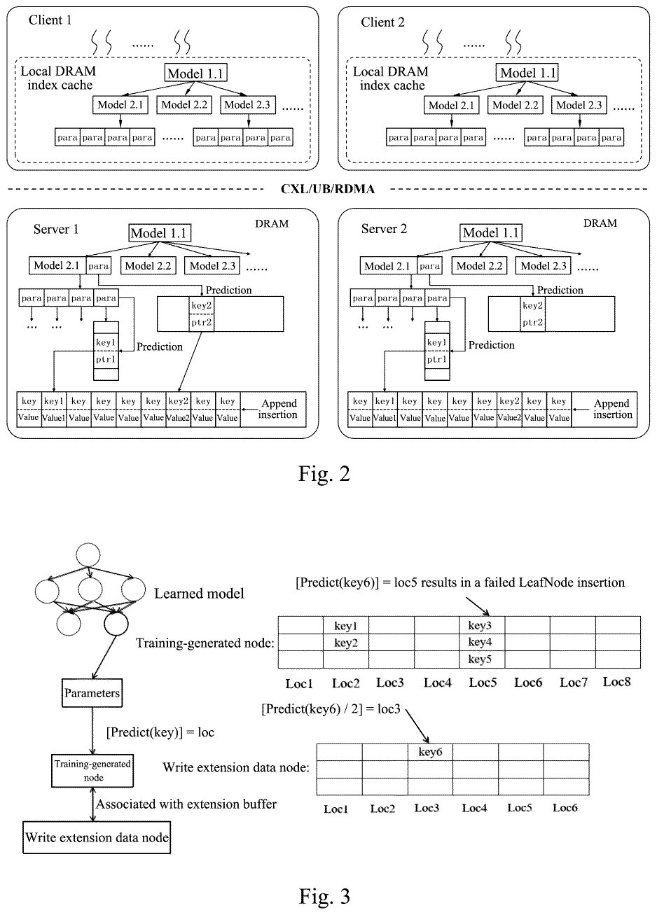

As shown in FIG. 1, with RDMA networking established, data exchange occurs between compute-pool servers and memory-pool servers, but not among compute-pool servers or among memory-pool servers. As shown in FIG. 2, Client 1 and Client 2 serve as compute-pool server nodes.

In the disaggregated-memory-based learned index write extension system of the present disclosure, a write delta buffer of reuse model is constructed on the memory-pool server to absorb newly inserted key-value pairs. The compute-pool server holds a pointer to the write delta buffer of reuse model and determines the insertion location of key-value pairs based on the linear model in the cached learned index model.

Specifically, the compute-pool server leverages the monotonically increasing property of the linear model in the learned index structure (i.e., larger key yield larger locations computed by the linear model) to determine insertion locations for subsequent key-value pairs. Each linear model covers a distinct key-value pair range, requiring each submodel to maintain a separate write delta buffer. The model-predicted location range is normalized to a predetermined write delta buffer size by scaling the range proportionally to cover the locations of all storage buckets within the write delta buffer.

Since model parameters occupy minimal space, pointers occupying minimal space are sufficient to index the write delta buffer for write extension, allowing the index to be fully cached in the compute-pool server's local DRAM. This enhances index cache access efficiency, eliminating cache misses due to insufficient local DRAM space, thereby enhancing key-value pair access efficiency. In contrast, a cache miss would require the compute-pool server's CPU to initiate access to the remote global index and perform cache replacement.

The memory-pool server constructs the learned index model and the write delta buffer of reuse model to absorb newly inserted key-value pairs. In other words, the learned index model is built in the memory of the memory-pool server, cached in the local DRAM of the compute-pool server, and accessed by working threads on the compute-pool server's CPU.

The learned index model comprises a three-layer structure.

The bottom layer consists of submodels, including pointers to data nodes, pointers to write delta buffers reusing model parameters, model parameters, data nodes, maximum value of the storage range for write extension data nodes (termed the anchor key), and a global lock. These are trained using the PLR algorithm on initial key-value pairs provided during the preload stage. Initial key-value pairs are sampled from historical data by an application using the disclosed index system, sorted in ascending order. The PLR algorithm segments these initial key-value pairs into non-overlapping submodels. Herein, initial key-value pairs are obtained by uniformly sampling historical key-value pair data after sorting keys by size, stored as files, and used as initial key-value pairs during the preload stage. Unlike common indexes, a learned index cannot be built from scratch and requires a preload process to read historical key-value pair characteristics of the application.

The middle layer comprises recursive index nodes of submodels, used for searching submodels, trained using the PLR algorithm.

The top layer contains data range segmentation nodes. The learned index model divides data ranges based on middle-layer model training, following a uniform distribution principle, and stores pointers to these ranges. The top layer yields a small number of data ranges, enabling binary search to locate the range for a specific key-value pair key, followed by a model search in the middle layer. If the middle layer, derived from the PLR algorithm, results in excessive data ranges, recursive segmentation using the PLR algorithm continues until the number of data ranges is sufficiently small (e.g., fewer than 10), forming the top layer. This enables efficient binary search at the top layer to identify the data range for a given key.

The compute-pool server is further configured to, during the preload stage, load initial key-value pairs to the memory-pool server, sort them in ascending order, and store the sorted results in the memory-pool. The PLR algorithm divides the sorted key-value into several submodels.

Preferably, each data node corresponds to a 48-byte submodel, with 8 bytes for the pointer to the data node, 16 bytes for model parameters, 8 bytes for the global lock, 8 bytes for the maximum key (i.e. anchor key), and 8 bytes to record the starting location of the write delta buffer. Submodel data is stored in the compute-pool server's local DRAM during this stage.

The write delta buffer calculates storage locations for new inserted key-value pairs using model parameters, leveraging their low space occupancy to significantly reduce indexing storage overhead.

Given that the compute-pool server's local DRAM (e.g., 4 GB) is significantly smaller than the memory-pool server's DRAM (e.g., up to 4 TB remotely), the index for large memory must be fully cached in the local DRAM to minimize microsecond-level accesses to uncached index structures in remote memory due to cache misses.

Submodels are recursively trained to generate the middle and top layers of the index. Continuous address space in the memory-pool server is initially allocated as write delta buffers based on the data node size of bottom-layer submodels in the learned index model.

Specifically, in point-query operations, read/write operations from the compute-pool server use the cached learned index model in local DRAM to calculate the first location offset Loc₁ and the second location offset Loc₂ in the data node and write delta buffer for the target key, then initiate an RDMA doorbell batching (an interface provided by the RDMA network programming library) to the memory pool.

The DRAM memory addresses specified in the RDMA doorbell batching are: Base₁+Loc₁*size Bucket and Base 2+Loc₂*size Bucket.

Base₁ and Base₂ are the addresses of the data node and write delta buffer in the memory pool, recorded by the learned index model cached in the compute-pool server's local DRAM. Bucket refers to a storage bucket for key-value pair in the data node and write delta buffer, a continuous address space capable of storing multiple key-value pairs.

The write delta buffer is a node formed by a continuous address space associated with a data node. When a new key-value pair is inserted, it is computed by the learned index model to fall within a specific submodel, which handles the storage of the newly inserted key-value pair.

In typical methods, maintaining the ordered relationship of key-value pairs within a submodel requires value comparisons using common structures like B+ trees or skiplists to absorb appended insertions. An overlooked fact is that the linear model used for predicting key-value pair storage location in read operations can also maintain and indicate the order of new insertions due to its order-preserving property (i.e., larger keys yield larger computed storage locations). Therefore, storage locations for newly inserted key-value pairs can be calculated without additional data structures (e.g., B+ trees, skiplists) for size comparisons.

The write delta buffer is a node formed by a continuous address space. The linear model calculates insertion locations for newly inserted key-value pairs, and the addresses size relationship reflects the key size relationship, ensuring newly inserted key-value pairs maintain ascending order and can be located during read operation via computation.

Anchor keys of submodels form a recursively trainable structure, with anchor keys as training keys and submodel pointers as values. The compute-pool server's CPU recursively trains submodels stored in local DRAM to generate the index to submodels (i.e. middle layer index). Depending on the index scale, the sorting process may be repeated to recursively generate higher middle layers until the scale is small enough to form the top layer. Middle- and top-layer models are stored in the compute-pool server's local DRAM.

For each bottom-layer submodel, the compute-pool server's CPU reads the corresponding data size recorded in local DRAM and initially allocates a continuous address space of the same size in the memory pool as the write delta buffer, sharing the submodel's training parameters.

Using RDMA Write technology, the compute-pool server's CPU transmits key-value pairs generated during the preload stage and the trained initial model via the RDMA NIC. The memory-pool server's RDMA NIC writes them into the memory pool using DMA technology, making the initial learned index model globally visible.

FIG. 3 illustrates the use of the write delta buffer in the write extension method of the present disclosure. The learned index model predicts the key of a key-value pair using the parameters of learned model (i.e. model parameters), yielding the model-predicted location loc. The training-generated node, a data node produced by the PLR algorithm, is associated with the write delta buffer to form a write extension data node.

As shown in the right part of FIG. 3, during training-generated node creation, [Predict(key6)]=loc5 results in a failed LeafNode insertion. In the write extension data node process, [Predict (key6)/2]=loc3.

By avoiding redundant size comparisons, the write extension method of the present disclosure eliminates the need for additional data structures (e.g., B+ trees, skiplists), reducing memory space requirements for write extension in the learned index model. The low-space-occupancy learned index supporting write extension is fully cached in the compute-pool server's limited local DRAM, enhancing index caching efficiency and key-value pair access throughput.

Retraining threads in the memory-pool server asynchronously retrain submodels, offloading the retraining process to the memory-pool server. These threads scan and train key-value pairs within submodels, generate new bottom-layer submodels, update write delta buffers, and dynamically adjust buffer sizes based on data insertion characteristics within submodel coverage.

Working threads on the compute-pool server's CPU communicate with those on the memory-pool server's CPU using bilateral RDMA primitives from an open-source RDMA library, marking messages in the data packets as “retraining” to offload submodel retraining processes to the memory-pool server.

The memory-pool server's CPU working threads request new retraining threads to asynchronously retrain submodels. Offloading retraining processes to the memory-pool server prevents key-value pairs in the training range from being transmitted back to the compute-pool server's local DRAM via the memory-pool server's RDMA NIC, conserving limited RDMA network bandwidth and improving retraining efficiency.

The retraining thread scans and trains key-value pairs in the submodel using the PLR algorithm, generating new bottom-layer submodels with respective data nodes and new write delta buffers reusing updated parameters. The thread then notifies compute-pool servers of retraining results via bilateral RDMA primitives. Each compute-pool server synchronizes the retraining results, maintaining both new and old versions of the original submodel's data node. New data node insertions and redirected old key-value pair insertions occur on the new data node. Read operations access both new and old data nodes, ensuring the offloaded retraining process does not block write operations, achieving true decoupling of insertion and retraining offloading.

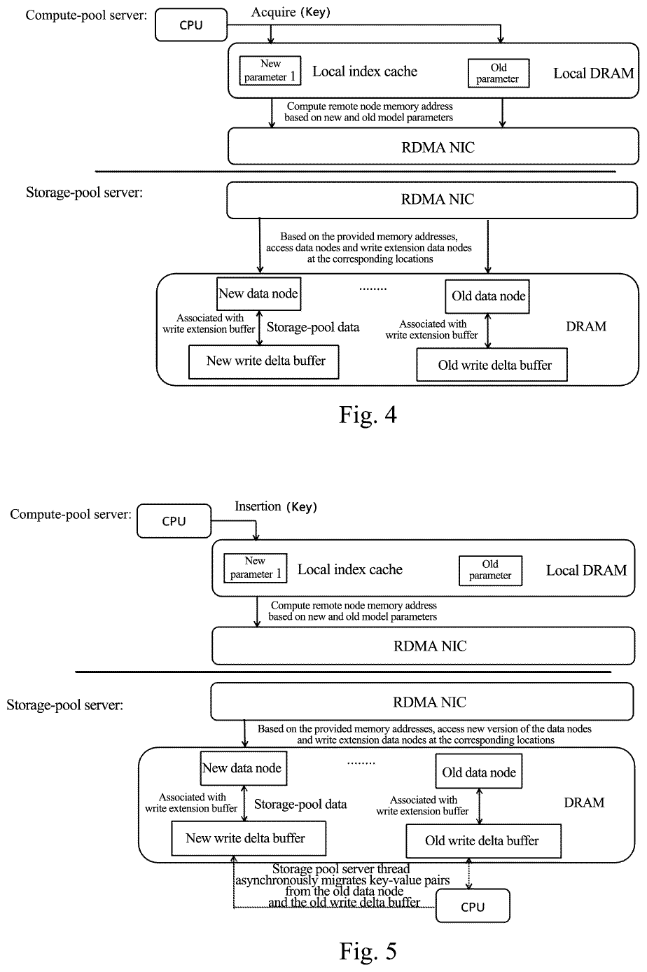

Preferably, FIG. 4 and FIG. 5 illustrate data access paths during the insertion-retraining decoupling process under a multi-version mechanism.

As shown in FIG. 4, the compute-pool server's CPU acquires new parameters from the retrained old model, retraining both new and old model parameters. It writes new parameters to the local DRAM, forming a local index cache. The compute-pool server computes remote node memory addresses using new and old model parameters and transmits them to the memory-pool server via the RDMA NIC.

The memory-pool server's RDMA NIC accesses corresponding data nodes and writes new data nodes based on the provided memory addresses. In the memory-pool server, training-generated nodes are associated with the write extension buffer, forming new data nodes for subsequent writes.

Alternatively, training-generated nodes are associated with the write extension buffer, forming unmodifiable old data nodes.

As shown in FIG. 5, the memory-pool server' CPU memory-pool node thread asynchronously migrates old data nodes to the new write delta buffer, forming new data nodes for subsequent writes.

As shown in FIG. 5, the memory-pool server's CPU retraining thread asynchronously migrates data from old data nodes and old write delta buffers in the memory-pool DRAM to new data nodes and new write delta buffers. Upon completion, the retraining thread reports the status to the memory-pool server's CPU management thread, which transmits the results to each compute-pool server's local DRAM via bilateral RDMA primitives, completing the retraining offloading process.

Preferably, the memory-pool server is configured to: monitor bilateral RDMA primitive messages from the compute-pool server via a predetermined management thread; transmit anchors of intervals where retraining occurs as parameters; search for anchors in the bilateral RDMA primitive messages using the learned index model, and retrain old submodels into new submodels based on search results; populate model parameters and corresponding anchor information for the new submodels, and allocate data nodes and write delta buffers; and have the management thread send the new submodels to each compute-pool server via bilateral RDMA primitives, enabling the compute-pool servers to update submodels.

The memory-pool server runs a management thread on its CPU to monitor bilateral RDMA primitive messages from the compute-pool server. The compute-pool server's CPU working thread sends messages encapsulated with bilateral RDMA primitives via its RDMA NIC to the memory-pool server's RDMA NIC, which are then transferred to the memory pool using DMA technology, detected by the memory-pool server's CPU management thread. The message type is “retraining”, with the anchor key of the retraining interval being the anchor key recorded by the submodel.

Upon receiving the messages, the memory-pool server's CPU management thread initiates an asynchronous thread, passing the anchor key of the retraining interval as a parameter. The asynchronous thread searches the learned index model in the memory-pool DRAM to locate the old submodel to be retrained, then uses the PLR algorithm to retain key-value pair data in the data nodes and write extension nodes covered by the submodel, generating several new submodels.

By repackaging bilateral RDMA primitive messages, the retraining process, typically executed by the compute-pool server' CPU, is offloaded to the memory-pool server's CPU. This avoids transmitting key-value pair data to be retrained over the RDMA network, preventing waste of limited RDMA network bandwidth and enhancing the index system's overall throughput.

According to a preferred embodiment, the retraining thread asynchronously migrates data from old submodels and old write delta buffers to new submodels and new write delta buffers, reporting completion to the management thread.

Preferably, the retraining thread on the storage node server's CPU populates model parameters and corresponding anchor key information for new submodels, allocating data nodes and write delta buffers in the memory pool. The data node size, Size_{Node}, is determined during algorithm execution. After segmenting key-value pairs in the old submodel's data nodes and write delta buffers using the PLR algorithm, the number of key-value pairs in the original data node, N₁, and the number of key-value pairs in the write delta buffer, N₂, are counted for each segment. The write delta buffer size is calculated as follows:

$${Size}_{Buffer} = min ( {N}_{2} / {N}_{1} * {Size}_{Node} , 2 * {Size}_{Node} ) , when {N}_{2} / {N}_{1} > 1 ;$$

$${Size}_{Buffer} = max ( {N}_{2} / {N}_{1} * {Size}_{Node} , 0.5 * {Size}_{Node} ) , when {N}_{2} / {N}_{1} < 1 ;$$

where Size_{Buffer} is the write delta buffer size, Size_{Node} is the data node size, N₁ is the number of key-value pairs in the original data node, and N₂ is the number of key-value pairs in the write delta buffer.

Based on these equations, the size of the new write delta buffer for the newly generated submodel is allocated in the DRAM of the memory-pool server.

The compute-pool server is further configured to: search the cached learned index model to determine a first location offset Loc₁ on the data node and a second location offset Loc₂ in the write delta buffer for the target access; and calculate the access space size for read/write operations as: Size=Size_{Bucket}*N; where Size_{Bucket} is the bucket size, Nis the number of linearly probed buckets, and Size is the access space size specified by the read/write operation. Thus, the access space ranges for the read/write operation are [Loc₁, Loc₁+Size] and [Loc₂, Loc₂+Size].

Using a posterior-aware method, if the write delta buffer contains more key-value pairs, the segment is identified as a hot segment, expected to absorb more newly inserted key-value pairs, and a larger write delta buffer is allocated for newly generated submodels in the memory-pool's DRAM. Conversely, a smaller write delta buffer is allocated. This adaptive approach prevents space waste from fixed-size write delta buffers.

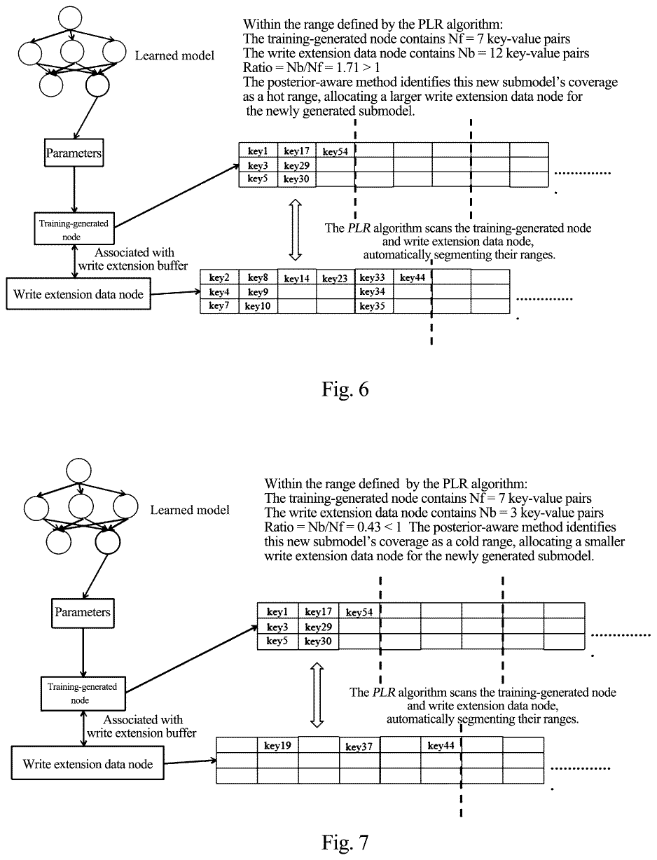

FIG. 6 and FIG. 7 illustrate optimized memory space usage ranges for the write delta buffer. As shown in FIG. 6, within the range defined by the PLR algorithm, the training-generated node contains Nf=7 key-value pairs, and the write extension data node contains Nb=12 key-value pairs, with a ratio of Ratio=Nb/Nf=1.71>1. The posterior-aware method identifies this new submodel's coverage as a hot range, allocating a larger write extension data node for the newly generated submodel. The PLR algorithm scans the training-generated node and write extension data node, automatically segmenting their ranges.

As shown in FIG. 7, within the range defined by the PLR algorithm, the training-generated node contains Nf=7 key-value pairs, and the write extension data node contains Nb=3 key-value pairs, with a ratio of Ratio=Nb/Nf=0.43<1. The posterior-aware method identifies this new submodel's coverage as a cold range, allocating a smaller write extension data node for the newly generated submodel. The PLR algorithm scans the training-generated node and write extension data node, automatically segmenting their ranges.

A method to optimize write delta buffer memory space utilization involves statically generating initial size regions for write delta buffers, allocating different sizes to different submodels to avoid unnecessary space waste from single buffer size.

Since data insertion characteristics vary across submodel coverage ranges, dynamically adjusting the initial write delta buffer size allocates larger buffers to ranges with more key-value pairs insertions and smaller buffers to those with fewer, optimizing the DRAM space utilization of memory-pool servers.

During the batch-loading stage, initial write delta buffers are sized equal to the data nodes to meet the expected data distribution from initial training. In the retraining stage, write delta buffer reallocation adjusts sizes based on the ratio of key-value pairs in the write delta buffer to those in the static index data node within the new submodel's coverage range. Additionally, to enhance write delta buffer space utilization, the compute-pool server's working thread uses linear probing to access multiple buckets in the write delta buffer at once, identifying accessible locations.

### Embodiment 2

This embodiment exemplifies Embodiment 1, omitting redundant descriptions.

Consider a cloud storage service provider offering object storage services, storing mappings from objid (Object ID) to obj_{content} (Object Content). Given the cloud platform's demand for efficient, elastic resource configuration, resource decoupling is critical to reducing operational costs. The cloud storage service provider adopts a disaggregated memory architecture and a learned index model orientated toward disaggregated memory, supporting write operations to deliver elastic, efficient object storage services. The specific steps are as follows:

S110: Construct a write delta buffer constructure using reused model parameters.

In the cloud storage service provider's data center platform, vast object data is stored as key-value pairs in the DRAM of the memory-pool server, which also hosts the learned index model. By reusing model parameters to construct the write delta buffer, metadata space for indexing write delta buffer is minimized, enabling the compute-pool server to fully cache the learned index model from the memory pool using its limited local DRAM. When a user performs a view operation on an object, the compute-pool server's working thread accesses the local DRAM index cache, locating and reading the object data's storage location in the memory-pool server with nanosecond-level latency. This eliminates the need for microsecond-level access to uncached index nodes, reducing response latency.

S120: Implement a retraining decoupling mechanism.

In the cloud storage service provider's object storage service, adding more object data may cause old model nodes to fail as newly inserted object IDs disrupt the learned distribution, necessitating retraining to generate new models. This prolonged retraining, triggered by object additions, could block the system, causing millisecond-level latency for insertion operations. The retraining decoupling mechanism removes retraining from the critical paths of insertion operations, ensuring rapid responses for users accessing the cloud storage service provider's object storage servers at any time.

S130: Implement a linear probing object storage mechanism.

Constructing write delta buffers by reusing the model trades memory-pool server space for read/write performance. Linear probing, during object insertion, sequentially searches for multiple continuous storage spaces after the insertion locations, increasing the write delta buffer's load factor and optimizing the DRAM space utilization of memory-pool servers.

By implementing the method of the present disclosure, the cloud storage service provider's object storage service, supporting learned index models for write operations, achieves the following technical benefits:

First, enhanced object data access efficiency: By directly accessing the fully cached learned index model in the compute-pool server's local DRAM to locate object data, the platform ensures rapid responses to user requests. For instance, reading an object's content yields results in sub-microsecond time, whereas uncached index traversal on the memory-pool server could incur microsecond- or even millisecond-level latency. Reduced CPU load on the compute-pool server also boosts system throughput, enabling the object storage service to handle more user requests per unit time.

Second, reduced response latency for object data access: During peak periods, frequent object insertions may trigger model retraining due to model invalidation. Decoupling insertion from retraining removes time-consuming retraining operations from the insertion critical path to avoid system blocking, ensuring low-latency responses and feedback for user object insertion operations.

Third, improved DRAM space utilization of the memory pool: Linear probing mechanism enables object data storage in continuous spaces following predicted locations, mitigating storage space waste from model prediction conflicts. This allows cloud storage service providers to deliver efficient object storage management with lower storage costs.

The described case demonstrates the successful application of a disaggregated-memory-oriented learned index model in a cloud storage service platform. By reusing model parameters for write delta buffers and decoupling insertion from retraining, the cloud storage service platform provides low-latency, high-throughput object storage services. Linear probing mechanism further reduces storage overhead, enabling the cloud storage service providers to stand out in a competitive market, enhancing user retention and engagement.

It should be noted that the above-mentioned embodiments are exemplary. Those skilled in the art, inspired by the present disclosure, may devise various solutions within the scope and protection of the present disclosure. Furthermore, those skilled in the art will recognize that the specification and accompanying drawings provided herein are illustrative and form no limitation to any of the appended claims. The protection scope of the present application is defined by the appended claims and their equivalents. The specification provided herein encompasses multiple inventive concepts, with terms like “preferably” or “according to a preferred embodiment” indicating distinct concepts in respective paragraphs. The applicant reserves the right to file divisional applications for each inventive concept.

What is claimed is:

1. A disaggregated-memory-based learned index write extension system, comprising:
compute-pool servers, holding a pointer to a write delta buffer of reuse model, and determining insertion location of key-value pairs based on a linear model in cached learned index model; and
memory-pool servers, constructing the learned index model and the write delta buffer of reuse model to absorb newly inserted key-value pairs;
wherein a retraining thread in the memory-pool server asynchronously retrains submodels; and the retraining thread scans and trains key-value pairs within the submodel, generates new bottom-layer submodels, and updates the write delta buffer, while dynamically adjusting size of the write delta buffer according to data insertion characteristics within coverage range of the submodel; and
the compute-pool server, based on execution results of the retraining thread of the memory-pool server, updates the cached submodels and the pointers held by the submodels pointing to the write delta buffer.

2. The system of claim 1, wherein the compute-pool server is further configured to:
during a preload stage, load initial key-value pairs to the memory-pool server, and sort the key-value pairs in ascending order;
divide the sorted key-value pairs into several submodels;
recursively train the submodels to obtain a middle layer and top layer of an index of the submodels; and
initially allocate a continuous address space in the memory-pool server as the write delta buffer based on the size of data nodes of the bottom-layer submodels of the learned index model.

3. The system of claim 2, wherein the memory-pool server is configured to:
monitor messages of a bilateral RDMA primitive technology from the compute-pool server based on a predetermined management thread;
pass anchors of intervals where retraining occurs as parameters;
based on the learned index model, search for the anchors in the messages of the bilateral RDMA primitive technology, and retrain old submodels into new submodels according to the search results;
fill model parameters of the new submodels and their corresponding anchor information, and allocate the data nodes and the write delta buffer; and
have the management thread send the new submodels to each compute-pool server using the bilateral RDMA primitive, enabling the compute-pool server to update the submodels.

4. The system of claim 3, wherein the memory-pool server is further configured to:
have the retraining thread asynchronously migrate data from old submodels and the old write delta buffer to the new submodels and the new write delta buffer, and notify the management thread of completion status upon completion.

5. The system of claim 4, wherein the compute-pool server is further configured to:
after segmenting the data nodes in the old submodels and the key-value pairs in the write delta buffer based on an Optimal Piecewise Linear Regression (PLR) algorithm, count the number of key-value pairs N₁ on the original data nodes and the number of key-value pairs N₂ in the write delta buffer in each segment;
wherein the size of the write delta buffer is calculated as follows:
$${Size}_{Buffer} = min ( {N}_{2} / {N}_{1} * {Size}_{Node} , 2 * {Size}_{Node} ) , when {N}_{2} / {N}_{1} > 1 ;$$
$${Size}_{Buffer} = max ( {N}_{2} / {N}_{1} * {Size}_{Node} , 0.5 * {Size}_{Node} ) , when {N}_{2} / {N}_{1} < 1 ;$$
where Size_{Buffer} represents the size of the write delta buffer, Size_{Node} represents the size of the data node, N₁ represents the number of the key-value pairs on the original data nodes, and N₂ represents the number of the key-value pairs in the write delta buffer.

6. The system of claim 5, wherein the compute-pool server is further configured to:
based on the cache of the learned index model, conduct a search to determine a first location offset Loc₁ on the data node to be accessed and a second location offset Loc₂ in the write delta buffer, and
calculate access space size for read/write operations as follows:
$$Size = {Size}_{Bucket} * N ;$$
where Size_{Bucket} represents the size of storage bucket, N represents the number of storage buckets for linearly probing, and Size represents the read space size specified by the read/write operations;
wherein the access space ranges for the read/write operations are [Loc₁, Loc₁+Size] and [Loc₂ Loc₂+Size].

7. The system of claim 6, wherein each data node corresponds to a 48-byte submodel,
wherein 8 bytes are used to store a pointer to this data node, 16 bytes are used to store model parameters, 8 bytes are used to store a global lock, 8 bytes are used to record the largest key in the data node, and the remaining 8 bytes are used to record the starting position of the write delta buffer.

8. The system of claim 7, wherein the submodel data is stored in the local DRAM of the compute-pool server at this stage.

9. The system of claim 8, wherein the system is configured to:
recursively train the submodels to obtain the middle layer and top layer of the index of the submodels; and
initially allocate a continuous address space in the memory-pool server as the write delta buffer based on the size of the data nodes of the bottom-layer submodels of the learned index model.

10. The system of claim 9, wherein the system is configured to:
for each bottom-layer submodel, have the CPU of the compute-pool server read the size of the data node corresponding to the recorded index from the local DRAM, initially allocate a continuous address space of the same size in the DRAM of the memory-pool server as the write delta buffer, and share the training parameters of the submodel.

11. A disaggregated-memory-based learned index write extension method, comprising:
setting a pointer to a write delta buffer of reuse model, and determining the insertion location of key-value pairs based on the linear model in the cached learned index model;
constructing the learned index model and the write delta buffer of reuse model to absorb newly inserted key-value pairs;
wherein a retraining thread is used to asynchronously retrain submodels to offload retraining processes to the memory-pool server; and the retraining thread scans and trains key-value pairs of the submodel, generates new bottom-layer submodels, and updates the write delta buffer, while dynamically adjusting the size of the write delta buffer based on data insertion characteristics within the coverage range of the submodel; and
based on the execution results of the retraining thread in the memory-pool server, updating the cached submodels and the pointers held by the submodels pointing to the write delta buffer.

12. The method of claim 11, wherein the method further comprises:
during the preload stage, loading initial key-value pairs to the memory-pool server and sorting the key-value pairs in ascending order;
dividing the sorted key-value pairs into several submodels;
recursively training the submodels to obtain the middle layer and top layer of the index of the submodels; and
initially allocating a continuous address space in the memory-pool server as the write delta buffer based on the size of data nodes of the bottom-layer submodels of the learned index model.

13. The method of claim 12, wherein the method further comprises:
monitoring messages of the bilateral RDMA primitive technology from the compute-pool server based on a predetermined management thread;
passing anchors of intervals where retraining occurs as parameters;
based on the learned index model, searching for the anchors in the messages of the bilateral RDMA primitive technology, and retraining old submodels into new submodels according to the search results;
filling the model parameters of the new submodels and their corresponding anchor information, and allocating data nodes and the write delta buffer; and
having the management thread send the new submodels to each compute-pool server using the bilateral RDMA primitive, enabling the compute-pool server to update the submodels.

14. The method of claim 13, wherein the method further comprises:
having the retraining thread asynchronously migrate data from old submodels and the old write delta buffer to new submodels and the new write delta buffer, and notify the management thread of completion status upon completion.

15. The method of claim 14, wherein the method further comprises:
after segmenting the data nodes in the old submodels and the key-value pairs in the write delta buffer based on an Optimal Piecewise Linear Regression (PLR) algorithm, counting the number of key-value pairs N₁ on the original data nodes and the number of key-value pairs N₂ in the write delta buffer in each segment;
wherein the size of the write delta buffer is calculated as follows:
$${Size}_{Buffer} = min ( {N}_{2} / {N}_{1} * {Size}_{Node} , 2 * {Size}_{Node} ) , when {N}_{2} / {N}_{1} > 1 ;$$
$${Size}_{Buffer} = max ( {N}_{2} / {N}_{1} * {Size}_{Node} , 0.5 * {Size}_{Node} ) , when {N}_{2} / {N}_{1} < 1 ;$$
where Size_{Buffer} represents the size of the write delta buffer, Size_{Node} represents the size of the data node, N₁ represents the number of the key-value pairs on the original data nodes, and N₂ represents the number of the key-value pairs in the write delta buffer.

16. The method of claim 15, wherein the method further comprises:
based on the cache of the learned index model, conducting a search to determine a first location offset Loc₁ on the data node to be accessed and a second location offset Loc₂ in the write delta buffer, and
calculating access space size for read/write operations as follows:
$$Size = {Size}_{Bucket} * N ;$$
where Size_{Bucket} represents the size of storage bucket, N represents the number of storage buckets for linearly probing, and Size represents the read space size specified by the read/write operations;
wherein the access space ranges for the read/write operations are [Loc₁, Loc₁+Size] and [Loc₂ Loc₂+Size].

17. The method of claim 16, wherein each data node corresponds to a 48-byte submodel, wherein 8 bytes are used to store a pointer to this data node, 16 bytes are used to store model parameters, 8 bytes are used to store a global lock, 8 bytes are used to record the largest key in the data node, and the remaining 8 bytes are used to record the starting position of the write delta buffer.

18. The method of claim 17, wherein the submodel data is stored in the local DRAM of the compute-pool server at this stage.

19. The method of claim 18, wherein the method further comprises:
recursively training the submodels to obtain the middle layer and top layer of the index of the submodels; and
initially allocating a continuous address space in the memory-pool server as the write delta buffer based on the size of the data nodes of the bottom-layer submodels of the learned index model.

20. The method of claim 19, wherein the method further comprises:
for each bottom-layer submodel, having the CPU of the compute-pool server read the size of the data node corresponding to the recorded index from the local DRAM, initially allocate a continuous address space of the same size in the DRAM of the memory-pool server as the write delta buffer, and share the training parameters of the submodel.
